(19) United States
(12) Patent Application Publication
(10) Pub. No.: US 2026/0286054 A1
(43) Pub. Date: Sep. 24, 2026

(54) POLYMERISATION OF SILOXANE POLYMERS

(71) Applicant: Dow Global Technologies LLC, Midland, MI (US)

(72) Inventors: Stephanie Barbon, Midland, MI (US); John Roberts, Midland, MI (US)

(21) Appl. No.: 19/475,629

(22) PCT Filed: May 20, 2024
(86) PCT No.: PCT/US2024/030196

§ 371 Date: Oct. 15, 2025

Related U.S. Application Data
(60) Provisional application No. 63/468,863, filed on May 25, 2023.

(51) Int. Cl. C08G 77/04; C08G 77/08; C08G 77/20

(52) U.S. Cl. CPC C08G 77/045; C08G 77/08; C08G 77/20

(57) ABSTRACT

This relates to a process for the polymerisation of siloxane polymers and copolymers, made by base catalysed ring-opening polymerisation of cyclosiloxane oligomers having six siloxane units per ring, using a sodium silanolate catalyst. It also relates to the siloxane polymers and copolymers, made by the process and their uses.

This relates to a process for the polymerisation of siloxane polymers and copolymers, made by base catalysed ring-opening polymerisation of cyclosiloxane oligomers having six siloxane units per ring, using a sodium silanolate catalyst. It also relates to the siloxane polymers and copolymers, made by the process and their uses.

Cyclosiloxane oligomers are formed by the hydrolysis of diorganodichlorosilanes and can be isolated by distillation. They are critical intermediates in the silicone industry as they are used as one of the main building blocks in the preparation of siloxane polymers and copolymers.

Each siloxane unit in a cyclosiloxane oligomer is typically of the structure:

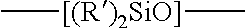

With each R′ group being the same or different and usually but not exclusively an alkyl group or an aryl group. Hence said cyclosiloxane oligomers may, for example, comprise dimethylsiloxane units, methylethyl siloxane units and/or phenylmethylsiloxane units in the ring.

The cyclosiloxane oligomers used as polymer building blocks typically have from 3 to 5 siloxane units in each cyclosiloxane ring. Usually, but not always, the cyclosiloxane oligomers have an average of about 4 siloxane units in each cyclosiloxane ring because octamethylcyclotetrasiloxane is probably one of the most abundant cyclosiloxane feedstocks and is often found to be the purest of the distilled cyclosiloxanes. That said, examples of such cyclosiloxane oligomers having 3 to 5 siloxane units per molecule include octamethylcyclotetrasiloxane, hexamethylcyclotrisiloxane, decamethylcyclopentasiloxane, cyclotetra(phenylmethyl)siloxane and mixtures thereof. However, octamethylcyclotetrasiloxane is essentially the only cyclosiloxane used in homogeneous base-catalyzed ring opening polymerization.

Typically, the cyclosiloxane oligomers and mixtures thereof, undergo a polymerisation process involving the ring opening of the cyclosiloxane oligomers in the presence of acid or base catalysts optionally with suitably end-blocked linear/branched polydiorganosiloxanes (end-blockers). An equilibrium between the desired siloxane polymers and a mixture of cyclosiloxane compounds is created in the course of the polymerisation reaction. The resulting equilibrium largely depends on the nature and number of cyclosiloxane compound(s), the catalyst used and the polymerisation process temperature.

When utilising octamethylcyclotetrasiloxane as the starting material it also tends to be the prevalent cyclosiloxane as a result of the equilibration. Given the basic or acidic nature of the catalysts used, such polymerisation processes are generally terminated or quenched by the addition of a neutralizing agent designed to react with the chosen acid or base catalyst to render it non-active. Where possible, catalyst residues are preferably removed from the resulting polymer product by an appropriate separation method, e.g., filtration.

Base catalysts which have been utilised include, but are not limited to, alkali metal hydroxides such as potassium or caesium hydroxide, alkali metal alkoxides or complexes of alkali metal hydroxides and an alcohol, alkali metal silanolates e.g. potassium silanolates prepared with siloxane oligomers or trimethylpotassium silanolate, phosphazene bases and the catalyst derived by the reaction of a tetra-alkyl ammonium hydroxide and a siloxane tetramer as described in U.S. Pat. No. 3,433,765.

Acid catalysts are used in some situations when preferred to base catalysts. Given base catalysts tend to degrade polymers containing Si—H groups, acid catalysts are typically used for polymers with Si—H functionality. They also tend to be used in the preparation of lower viscosity and commodity (trimethyl endcapped) siloxane polymers. Octamethylcyclotetrasiloxane is essentially the only cyclosiloxane used in homogeneous acid-catalyzed ring opening polymerization (vs acid clays used in condensation/equilibration polymerization).

Although many of these catalysts (both base catalysts and acid catalysts) are highly active, they tend to produce large quantities (i.e., greater than (>) 10 wt. % (100,000 ppm) of cyclic by-products), most often octamethylcyclotetrasiloxane, through the equilibrium reaction which occurs during the ring-opening polymerisation process.

There is a desire in the industry to reduce the reliance on cyclosiloxane oligomers having an average of about 4 siloxane units in processes for the preparation of siloxane polymers from cyclosiloxane ring starting ingredients and to reduce the generation of cyclosiloxane oligomers having an average of about 4 to 5 siloxane units as by-products from processes for the preparation of siloxane polymers from cyclosiloxane ring starting ingredients through equilibrium reactions.

There is provided herein a base catalysed process for the preparation of linear or branched siloxane polymers and copolymers, by the ring-opening polymerisation of cyclosiloxane oligomers having six siloxane units per ring

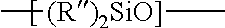

units per molecule, wherein each R″ group per unit is the same or different and is an alkyl group having from 1 to 6 carbons; which base catalysed process comprises the steps of
(a) introducing
   (i) said cyclosiloxane oligomers having six siloxane units per ring in an amount of from 50 to 99 wt. % of the starting ingredients with
   (ii) one or more end-blockers in an amount of from 1 to 50 wt. % of the starting ingredients and optionally
   (iii) a co-monomer selected from a linear organosiloxane co-monomer, a branched organosiloxane co-monomer or cyclosiloxane co-monomer wherein said cyclosiloxane co-monomer has from 3 to 10 —[(R⁸)(R⁹)SiO]—
      units per molecule, wherein each R⁸ group is the same or different and is selected from an alkenyl group, an alkynyl group, an aryl group, a fluoroalkyl such as trifluoropropyl or a perfluoroalkyl group and each R⁹ group is selected from an alkyl group having from 1 to 6 carbons or R⁸;
   said co-monomer (iii), when present, being present in an amount of from 1 to 50 wt. % of the starting ingredients;
      into a mixing vessel and mixing;
(b) optionally introducing an organic solvent in an amount of up to 30 wt. % of the starting ingredients into the mixing vessel during or subsequent to step (a);
(c) heating said starting ingredient (i) to a predetermined reaction temperature of from 25 to 175° C. in an inert atmosphere before introducing component (ii) and optionally component (iii), when present, or
   heating a mixture of starting ingredients (i), (ii) and optionally (iii) to a predetermined reaction temperature of from 25 to 175° C. in an inert atmosphere;
(d) once the predetermined reaction temperature has been reached, and starting materials (i), (ii) and optionally (iii) are thoroughly mixed together, introducing a final starting ingredient, a sodium silanolate base catalyst (iv) of the structure R²⁰—O⁻ Na⁺ where R²⁰ is an organopolysiloxane chain; in an amount of from 0.001 to 10 wt. % of the starting ingredients; thereby forming an initial reaction mixture;
(e) agitating the initial reaction mixture at the predetermined reaction temperature for up to 24 hours until a step (e) product within a desired number average molecular weight range and/or a cyclics equilibration is obtained;
(f) quenching the reaction after step (e) by either filtering off heterogeneous acid catalysts when used or by neutralising the step (e) product with a suitable acid to form a step (f) product;
(g) Cooling the step (f) product to ambient temperature to form a cooled step (g) product and optionally,
(h) Stripping volatile cyclosiloxanes the cooled step (f) product to give a final linear or branched siloxane polymer or copolymer.

The total amount of the complete reaction mixture resulting in step (d) is 100 wt. % of the starting ingredients.

There is also provided a use of a sodium silanolate base catalyst (iv) of the structure

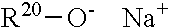

where R²⁰ is an organopolysiloxane chain; in the preparation of linear or branched siloxane polymers and copolymers, by the ring-opening polymerisation of cyclosiloxane oligomers having six siloxane units per ring having 6

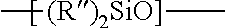

units per molecule, wherein each R″ group per unit is the same or different and is an alkyl group having from 1 to 6 carbons in accordance with the process described herein.

There is also provided a linear or branched siloxane polymers and copolymer obtained or obtainable from the process described herein.

### Cyclosiloxane Oligomers Having Six Siloxane Units Per Ring Starting Materials (i)

The cyclosiloxane oligomers having six siloxane units per ring starting materials (i) have six, siloxane units of the structure:

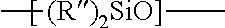

per cyclosiloxane oligomer as opposed to the standard four or five. However, each R″ group per unit is the same or different and is an alkyl group having from 1 to 6 carbons. Hence said cyclosiloxane oligomers may, for example, comprise dimethylsiloxane units, methylethyl siloxane units, diethylsiloxane units, methylpropyl siloxane units, dipropylsiloxane units and/or or tertiary butylmethyl siloxane units (tertiary butyl is hereafter referred to as ^{t}butyl). In one embodiment all the siloxane units in each molecule are the same. In another embodiment at least one R″ group per unit is a methyl or ethyl group, alternatively a methyl group. Hence, the cyclosiloxanes having six siloxane units per ring oligomer starting materials (i) may comprise, for the sake of example include but are not limited to:
dodecamethylcyclohexasiloxane ([(CH₃)₂)SiO]₆)
dodecaethylcyclohexasiloxane ([(C₂H₅)₂)SiO]₆),
dodecapropylcyclohexasiloxane ([(C₃H₇)₂)SiO]₆),
cyclohexa(methylethyl)siloxane ([(CH₃)(C₂H₅)SiO]₆),
cyclohexa(methylpropyl)siloxane ([(CH₃)(C₃H₇)SiO]₆),
and mixtures thereof.

The cyclosiloxane oligomers having six siloxane units per ring starting materials are present in the starting composition in an amount of from 50 to 99 wt. % of the starting ingredients, alternatively from 70 to 99 wt. %, alternatively from 75 to 99 wt. %, alternatively from 85 to 99 wt. %.

### End-Blockers (ii)

The one or more end-blockers are present in an amount of from 0.75 to 50 wt. % of the starting ingredients, alternatively from 0.75 to 25 wt. % of the starting ingredients, alternatively from 0.75 to 15 wt. % of the starting ingredients, alternatively from 1.0 to 10 wt. % of the starting ingredients.

They are utilised in order to regulate the molecular weight of the polymer and/or to add terminal functionality. End-blocking agents (end-blockers) are a means of controlling the reactivity/polymer chain length of the polymer and as a means of introducing functionality to the resulting polymer. The end-blocking agent halts the polymerization reaction and thereby limits the average molecular weight of the resulting polymer. Any suitable end-blocking agent known to those skilled in the art may be utilised and typically will be chosen with the end use of the polymer in mind.

Suitable end-blocking agents (end-blockers) include functionally terminated polysiloxanes having a degree of polymerisation of from 2 to 2500, for example, functionally terminated short chain (e.g., from a degree of polymerisation of from 2 to 30 silicon atoms) polysiloxanes or disiloxanes such as alkenyl dialkyl-terminated polydimethylsiloxanes; polydimethylsiloxanes (having from 2 to 2000 silicon atoms in the polymer backbone) dialkylsilanol-terminated or dialkylalkenyl-terminated, e.g., dialkylvinyl-terminated or dialkylhexenyl-terminated. The functional termination mentioned above preferably involves the inclusion of at least one alkenyl group per molecule, for example vinyl and hexenyl groups.

They may also include trialkyl-terminated polydimethylsiloxanes as well as mixtures of any of the above. Other potential end-blockers include silanes, e.g., alkoxy functional silanes and silanols such as trimethyl silanol, trimethylmethoxysilane, and/or methyltrimethoxysilane. Specific suitable end-blockers for the present process include but are not limited to dimethylalkenyl-terminated polydimethylsiloxanes having a degree of polymerisation of from 10 to 350 such as dimethyl vinyl-terminated polydimethylsiloxanes having a degree of polymerisation of from 10 to 100 and dimethylhexenyl-terminated polydimethylsiloxanes having a degree of polymerisation of from 100 to 350, as well as trialkyl-terminated polydimethylsiloxanes, usually trimethyl-terminated polydimethylsiloxanes having a viscosity of from 15 to 200 mPa·s at 25° C. such as XIAMETER™ PMX-200 Silicone Fluid 20 cSt, a trimethyl-terminated polydimethylsiloxane having a viscosity of 20 cSt at 25° C., commercially available from Dow Silicones Corporation of Midland, Michigan USA. The end-blockers may also comprise one or more disiloxanes such as hexamethyldisiloxane, 1,1,3,3-tetramethyldisiloxane, and 1,3-divinyltetramethyldisiloxane. However, preferably the end-blockers comprise at least one alkenyl group having from two to 6 carbons, typically a vinyl group or a hexenyl group.

Co-Monomers (iii)

Co-monomers (iii) are optionally present. When present co-monomer (iii) may comprise a co-monomer selected from a linear organosiloxane co-monomer, a branched organosiloxane co-monomer or cyclosiloxane co-monomer wherein said cyclosiloxane co-monomer has from 3 to 10

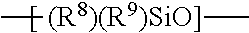

units per molecule, wherein each R⁸ group is the same or different and is selected from an alkenyl group, an alkynyl group, an aryl group, a fluoroalkyl such as trifluoropropyl or a perfluoroalkyl group and each R⁹ group is selected from an alkyl group having from 1 to 6 carbons or R⁸. When present the co-monomer (iii), is present in an amount of from 1 to 50 wt. % of the starting ingredients.

Co-monomer (iii) may comprise one or more cyclosiloxanes having from 3 to 10

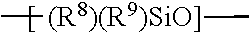

units per molecule, wherein each R⁸ group per is the same or different and is selected from an alkenyl group, an alkynyl group, an aryl group, a fluoroalkyl such as trifluoropropyl or a perfluoroalkyl group and each R⁹ group is selected from an alkyl group having from 1 to 6 carbons or R⁸. The cyclic co-monomers may include for the sake of example methylvinylsiloxane units, trifluoroalkylmethylsiloxane units, e.g., trifluoropropylmethylsiloxane units and/or phenylmethylsiloxane units in the ring. The cyclic co-monomers may for example include but are not limited to one or more of the following:
[(CH₃)(CH═CH₂)SiO]_{n′}, (CH₃)((CH₂)₄ CH═CH₂)SiO]_{n′}, [(CH₃)(Ph)SiO]_{n′}, (where Ph=phenyl), ([(Ph)₂SiO]_{n′}, [(CF₃(CH₂)₂)(CH₃)SiO]_{n′}, and cyclic aminosiloxanes such as (CH₃)(NH₂)SiO]_{n′} and/or [(CH₃)(—(CH₂)₃NH(CH₂)₂NH₂)SiO]ₙ and mixtures comprising at least one of the above. Whilst the number of siloxane groups in cyclic co-monomers can be from 3 to 10, in a preferred embodiment said co-monomers are macrocyclic cyclosiloxane oligomers having from 6 to 10 siloxane units. Of the above ring structures, cyclic siloxanes having six or seven siloxane units are particularly preferred e.g., tetradecamethylcycloheptasiloxane, cyclohexa(methylvinyl)siloxane, cyclohepta(methylvinyl)siloxane, cyclohexa(phenylmethyl)siloxane cyclohepta(phenylmethyl)siloxane, cyclohexa(trifluoropropylmethyl)siloxane and cyclohepta(trifluoropropylmethyl)siloxane.

Alternatively, or additionally, when present co-monomer (iii) may comprise or consist of a trialkyl silyl-terminated linear or a trialkyl silyl-terminated branched organopolysiloxane. The trialkyl silyl-terminated linear or a trialkyl silyl-terminated branched organopolysiloxane may comprise multiple units of the structure:

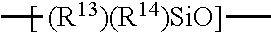

per molecule, wherein each R¹³ group per siloxane unit is the same or different and is selected from an alkenyl group, an alkynyl group, an aryl group, a fluoroalkyl such as trifluoropropyl or a perfluoroalkyl group or a primary or secondary amine groups or alkylethylenediamine groups and each R¹⁴ group is selected from an alkyl group having from 1 to 6 carbons or R¹³.

The linear organopolysiloxane co-monomer and branched organopolysiloxane co-monomer may comprise dialkylsilanol-terminated polydiorganosiloxanes having alkenyl containing and/or amine containing side chains. The alkenyl containing side chains may contain from 2 to 10 carbons, e.g., vinyl groups, propenyl groups, n-butenyl groups, n-pentenyl groups and n-hexenyl groups. The amine containing side chains may comprise primary or secondary amines or alkyl ethylenediamine groups wherein the alkyls have 2 to 10 carbons, alternatively, 2 to 7 carbons, alternatively 3 to 6 carbons, such as, for the sake of example groups such as —(CH₂)₃NH(CH₂)₂NH₂, —(CH₂)₂NH(CH₂)₂NH₂, —CH₂CH(CH₃)CH₂NH(CH₂)₂NH₂ and —(CH₂)₄NH(CH₂)₂NH₂ or mixtures thereof.

Co-monomer (iii), when present, is present in an amount of from 1 to 50 wt. % of the starting ingredients, alternatively from 1 to 25 wt. % of the starting materials, alternatively, from 1 to 15 wt. % of the starting materials, alternatively from 1 to 10 wt. % of the starting materials.

Surprisingly, it was found co-monomers (iii), including both cyclosiloxane and hydrolysate co-monomers, can be easily incorporated at relatively low levels (<10 wt. %) under milder reaction conditions, in particular at lower temperatures at which polymerisation of the macrocyclic cyclosiloxane oligomers having six siloxane units per ring proceeds.

Co-monomers (iii) can be incorporated into the mixture in several ways. For example, they can be equilibrated in from homopolymers of the co-monomer or added as reactive monomers.

Hydrolysate co-monomers may be functional cyclosiloxane cyclics hydrolysate (a mixture of cyclosiloxanes and silanol-terminated homopolymer), or a functional homopolymer.

### Organic Solvent

As indicated an optional organic solvent may be introduced in accordance with step (b) if desired. The organic solvent concerned may be, for example, a linear, branched or cyclic aliphatic hydrocarbon which may optionally be chlorinated, linear, branched or cyclic ethers or aromatic solvents. For example, the organic solvents may be aprotic organic solvents, such as tetrahydrofuran, toluene, or dichloromethane. The organic solvent, when present, is different from the cyclic oligomer (i), end-blocker (ii) and co-monomer (iii) starting ingredients described above. When present the organic solvent, may be used to deliver one or more of the other starting materials. For example, a starting material such as the catalyst may be dissolved in an organic solvent before combining with the other ingredients. The organic solvent may be used to deliver one or more starting materials e.g., said catalyst and then the reaction may proceed in organic solvent. The amount of organic solvent depends on various factors including the type and amount of the other starting materials selected and on whether one or more starting materials is/are being delivered in an organic solvent, or whether the reaction will proceed in an organic solvent.

Whilst an organic solvent may be incorporated into the composition in optional step (b), it is not usually preferred as it can be advantageous, if possible, to undertake the polymerisation neat i.e., in the absence of organic solvent. When an organic solvent is present, step (b) may involve introducing said organic solvent in an amount of up to 7.5 wt. % of the starting ingredients into the mixing vessel during or subsequent to step (a), the organic solvent concerned is typically an organic solvent such as linear, branched or cyclic aliphatic hydrocarbon which may optionally be chlorinated, linear, branched or cyclic ethers or aromatic solvents. For example, the organic solvents may be aprotic solvents, such as tetrahydrofuran, toluene, or dichloromethane. The organic solvent, when present, is different from the cyclic oligomer (i), end-blocker (ii) and co-monomer (iii) starting ingredients described above. However, preferably no organic solvent is introduced into the mixing vessel during or subsequent to step (a) and as such the process has then been undertaken “neat”.

### Sodium Silanolate Base Catalyst (iv)

Once the predetermined reaction temperature has been reached at the end of step (c), in step (d), a final starting ingredient, a sodium silanolate base catalyst (iv), is introduced into the composition to form the complete reaction mixture. The catalyst is a sodium silanolate base catalyst of the structure

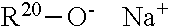

where R²⁰ is an organopolysiloxane chain, wherein the organopolysiloxane chain R²⁰ may have the structure

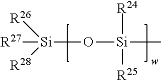

In which each R²¹ may be the same of different and comprises an alkyl group having from 1 to 10 carbons, alternatively from 1 to 6 carbons, alternatively from 1 to 4 carbons, alternatively is a methyl or ethyl group, said alkyl group may be a substituted alkyl group containing chloro-substituted alkyl groups or fluoro-substituted alkyl groups; each R²¹ may be the same or different and may be R²⁴ or an alkenyl group having from 2 to 10 carbons alternatively from 2 to 6 carbons, alternatively a vinyl group or a hexenyl group, an alkynyl group having from 2 to 10 carbons, a alternatively from 2 to 6 carbons, alternatively from 2 to 4 carbons alternatively an ethynyl group; an aromatic group, such as a phenyl group or an alkoxy group having from 1 to 10 carbons, alternatively from 1 to 6 carbons, alternatively from 1 to 4 carbons,

Each of R²⁶, R²⁷ and R²⁸ may be the same or different and may be a hydroxyl group or R²⁵. Each w is integer of from 2 and 200, alternatively from 2 and 150, alternatively from 2 and 125, alternatively from 2 to 100, alternatively from 2 to 75 when introduced into the composition as starting ingredient (iv).

The R²⁰—O⁻ Na⁺ may dimerize and as such the sodium silanolate base catalyst (iv) may be at least partially in a dimeric form.

The base catalyst (iv) may be introduced into the mixture dissolved in or suspended in one of the other staring ingredients (i), (ii) or (iii) when the latter is present or an alternative cyclosiloxane, alternatively in component (i).

The sodium silanolate base catalyst (iv) may be present in the amount of from 0.001 wt. % to 10 wt. % of the starting ingredients, alternatively 0.01 wt. % to 5 wt. %.

In the process described herein, cyclosiloxane oligomers having six siloxane units per ring (i) and co-monomer(s) (iii) when present are preferably, introduced into the mixing vessel dry. They may be dried by any suitable process, such as, for example, drying over molecular sieves or the like or by distillation and nitrogen stripping. The mixing vessel may be any suitable type of mixing vessel for example a batch mixer.

Historically, the ring opening polymerisation of cyclosiloxane oligomers having four siloxane units per ring (e.g., octamethylcyclotetrasiloxane) is carried out at a temperature of at least 160° C. In step (c) of the process herein, however, whilst the mixing vessel, e.g., batch reactor may be heated to a pre-determined reaction temperature, for example up to as high as 175° C. Preferably the pre-determined reaction temperature for the base catalysed ring-opening polymerisation of macrocyclic cyclosiloxane oligomers described herein is from greater than (>) 25° C. to 175° C. but advantageously can be in the range of from 100° C. to 175° C., alternatively in the range of from 125° C. to 175° C. The reaction is undertaken in an inert atmosphere, i.e., under nitrogen and/or argon, alternatively under nitrogen.

Once the initial reaction mixture has reached the desired temperature in step (c) sodium silanolate base catalyst (iv) is added to form the complete reaction mixture in step (d). Subsequent to the addition of sodium silanolate base catalyst (iv) the ring-opening polymerisation reaction takes place in step (e). The contents of the reaction vessel during step (e) are agitated in any suitable way e.g., by stirring the contents of the reaction vessel, by shaking or sonicating or the like the reaction vessel itself throughout the reaction process step (e) for up to 24 hours.

### Neutralising Agent

Any suitable neutralising agent may be used in step (f) to quench the reaction after step (e) and to form a step (f) product. These may include for the sake of example mild acids e.g., mild Lewis acids effective for neutralizing the sodium silanolate base catalyst (iv). Such neutralizing agents can be selected from, for example, acetic acid, phosphoric acid, trimethylsilylated phosphoric acid, tris(chloroethyl)phosphite, silyl phosphate, polyacrylic acid, chlorine substituted silanes, carbon dioxide, and suitable buffers such as mono sodium phosphate (NaH₂PO₄), or di sodium phosphate (Na₂HPO₄) or another suitable acidic neutralising agent to deactivate the sodium silanolate base catalyst (iv).

One neutralising agent which may be utilised is the weak Lewis acid carbon dioxide which functions when used in conjunction with silanolate catalysts. For example, when the sodium silanolate base catalyst (iv) used is a sodium trialkyl silanolate the neutralising agent will typically react with the sodium trialkyl silanolate to form sodium bicarbonate salt end groups and other sodium salts. Other neutralizing agents such as silyl phosphonates, a silylated phosphoric acid such as trimethylsilylated phosphoric acid and octyl silyl phosphonate optionally provided in a suitable solvent), and fumed silica may be utilised alone or in combination with the silanols.

When the polymer produced is via a batch process any suitable neutralising agent may be utilised. However, when the polymer is produced in a continuous reactor as described above, the neutralising agent may be selected dependent on the product being prepared, for example, low viscosity polymers, e.g., about 100,000 mPa·s or less, at 25° C. can be neutralised with such neutralising agent silyl phosphate and higher viscosity polymers, e.g., greater than (>) about 100,000 mPa·s at 25° C. may be neutralised with CO₂. Any suitable method to measure viscosity may be utilised for example viscosity may be measured using a Brookfield cone and plate Viscometer such as a Brookfield LVDV-E viscometer.

Once quenching e.g. neutralisation has been completed in said step (f), the reaction mixture is cooled to ambient temperature in step (g) to form a step (g) product which is the final linear or branched siloxane polymer or copolymer and which is then typically removed from the reaction vessel, e.g., batch reactor and collected or optionally undergoes stripping step (h) to remove remaining volatile materials from the step (g) product to give the final linear or branched siloxane polymer or copolymer.

Optional step (h), the stripping of the step (g) product, may be undertaken using any suitable means, for example using a wiped film evaporator or WFE. The WFE is designed to continuously strip out volatile compounds by mechanically vibrating a thin film, in this case, the final linear or branched siloxane polymer or copolymer on a heated surface at a temperature, in a range of from 20° C. to 210° C. Alternatively, optional step (h) may be undertaken using an aluminum pan with a heating element placed over it, again at a temperature, in this case, in a range of from 20° C. to 210° C.

If desired the resulting final linear or branched siloxane polymer or copolymer maybe evaluated for molecular weight, cyclosiloxane content, cyclosiloxane makeup, and optionally non-volatile content subsequent to completion of the process.

Hence, in one embodiment, i.e., when the intention is to make linear polydimethylsiloxane via the ring opening polymerisation of cyclosiloxane oligomers having six siloxane units per ring having six siloxane units per cyclic ring, the process may be as follows:
Introducing starting ingredient (i) into a polymerisation reaction and heating same to a predetermined reaction temperature before introducing starting ingredient (ii) and optionally (iii) mixing together at the predetermined reaction temperature; or
Introducing starting ingredients (i) and (ii) and optionally (iii) into a polymerisation reaction and heating same to a predetermined reaction temperature;
Introducing base catalyst (iv) into the mixture resulting from either of the above;
Reacting the starting ingredients for a predetermined period of time and then neutralising the mixture with a suitable neutralising agent; such as silyl phosphate for low viscosity polymers or CO₂ for high viscosity polymers;
Cooling the neutralised reaction product and optionally stripping off residual volatiles from the reaction product.

The reaction may be undertaken after the catalyst is introduced by feeding the reaction mixture into a plug flow type reactor having a series of stacked vessels with a central agitator, with the reaction mixture flow being top-down and the viscosity of the polymer being produced increasing with residence time as it moves down and subsequently out of the reactor with neutralization taking place after exit from the plug flow type reactor.

As discussed elsewhere neutralization may be with silyl phosphate for low viscosity polymers or CO₂ for high viscosity polymers.

Although optional it will be preferred to strip the polymer product resulting from the above process of volatiles. This may be completed using a suitable wiped film evaporator as discussed herein. Typically, the predetermined reaction temperature is between 4° and 150° C., alternatively between 5° and 125° C., alternatively between 6° and 125° C., alternatively between 6° and 110° C.

A major difference is the need to heat the polymer post neutralization for the wiped film evaporator (sometimes referred as a WFE). Also, a smaller WFE could be used due to the lower level of cyclics needed for removal in the finished polymer. It will be appreciated that this alternative process is performed neat, i.e., negating the need for removal of organic solvent after the polymerization process is complete. Furthermore, the presence of endblocker in this system allows for precise control over the molecular weight and properties of the resulting materials.

### Final Linear or Branched Siloxane Polymer or Copolymer

The process described herein produces a final linear or branched siloxane polymer or copolymer, which can be of any appropriate molecular weight and/or degree of polymerisation. For example, the number average molecular weight (Mn) or weight average molecular weight (Mw) may be at least 2500 Da, alternatively at least 5000 Da i.e., in a range of from 5000 Da to 100,000 Da, alternatively when Mn has reached a value of from 5000 Da to 30,000 Da determined using the size exclusion chromatography described in the Examples herein. Typically, the degree of polymerisation of the final linear or branched siloxane polymer or copolymer, produced via the process herein may be of any desired suitable chain length. It may be as short as 10 but is typically greater than (>) 50, alternatively >100, alternatively >300, alternatively >400, alternatively >500, alternatively >1000, alternatively >1500, and alternatively >2000.

Furthermore, advantageously the resulting product has a low cyclosiloxane, particularly octamethylcyclotetrasiloxane and decamethylcyclopentasiloxane, content e.g., less than (<) 10 wt. % (100,000 ppm), alternatively <8 wt. % (80,000 ppm), alternatively <7 wt. % (70,000 ppm).

As previously indicated, contrary to the disclosure herein, the cyclosiloxane oligomers used as polymer building blocks typically have an average of from 3 to 5 siloxane units in each cyclosiloxane ring. Usually, but not always, the cyclosiloxane oligomers have an average of about 4 siloxane in each cyclosiloxane ring units (i.e., octamethylcyclotetrasiloxane). This is typically because siloxane rings having four siloxane units per ring, especially octamethylcyclotetrasiloxane are, probably the most abundant cyclosiloxane feedstock and are often found to be the purest of the distilled cyclosiloxanes. However, ring opening polymerisation of such cyclic oligomers results in an equilibrium between the resulting polymer and cyclic siloxane by-products, especially octamethylcyclotetrasiloxane which are increasingly undesired. Surprisingly, however, it has now been determined that the use of cyclosiloxane oligomers having six siloxane units per ring starting materials (i) as described herein, especially dodecamethylcyclohexasiloxane are suitable for polymerizing with sodium silanolate type vase catalysts with the advantage that the proportion of octamethylcyclotetrasiloxane remaining after polymerisation as a by-product is significantly reduced. Furthermore, the cyclosiloxane oligomers having six siloxane units per ring starting materials (i) as described herein, can undergo polymerisation under milder conditions or can be used to polymerize at rates at or far exceeding the rate of polymerization of cyclosiloxane oligomers which have an average of from 3 to 5 siloxane units per molecule, which will allow for increased production volume, or the ability to run the reactions at lower temperatures. Advantageously, running these polymerizations at lower temperatures tend to result in the generation of polymer products with lower levels of cyclosiloxane by-products post reaction (ca. 1 wt. %) vs the typical 5 wt. % or more e.g., 5 to 15 wt. % octamethylcyclotetrasiloxane as a by-product when starting with octamethylcyclotetrasiloxane and/or decamethylcyclopentasiloxane.

A further advantage using the process herein is that these materials may be polymerized in bulk reactions with e.g., an alkenyl endblocker negating the need to use organic solvents or additional reagents, unless specifically desired or required.

Whilst this process is largely directed to the generation of polymers. even with large amounts of co-monomers (iii) present in the complete reaction mixture it was found that polymers were easily prepared in the presence of cyclosiloxane oligomers having six siloxane units per ring starting materials (i). This was considered quite surprising as it was anticipated that the resulting polymers would be likely to polymerise into a dimethylsiloxane homopolymer form and fail to incorporate components (ii) and (iii) into the polymer produced.

Furthermore, if desired, resulting final linear or branched siloxane polymer or copolymers produced by the process herein may contain pendant functionality as a result of base catalysis with such enhanced kinetics.

Current ring opening polymerisation (ROP) of cyclic siloxanes proceeds via an equilibration polymerisation reaction pathway which results in polymer preparation in conjunction with the production of cyclic oligomer equilibrium by-products (especially octamethylcyclotetrasiloxane). However, it has unexpectedly been identified that the base catalysed polymerisation process described herein produces much lower levels of the cyclic oligomers such as octamethylcyclotetrasiloxane as by-products of the equilibration polymerisation process. Whilst it is advantageous to use said cyclosiloxane oligomers having six siloxane units per ring as component (i) has the significant advantage that both end-blockers (ii), preferably end-blockers containing at least one alkenyl end-blocker as described herein, and co-monomers (iii) are readily incorporated into the resulting polymer if desired. Indeed, it was identified that even with large amounts of co-monomer (iii) present polymer could be readily made using cyclosiloxane oligomers having six siloxane units per ring as component (i) i.e., dodecamethylcycloheptasiloxane.

The polymers resulting from the polymerisation of cyclosiloxane oligomers having six siloxane units per ring as described herein, may be utilised as the siloxane polymer ingredient in any composition utilising siloxane polymers. For example, a standard siloxane polymer used the preparation of liquid silicone rubber compositions or condensation cure sealants and adhesives may be replaced by an equivalent siloxane polymer as made by the process described herein.

### EXAMPLES

These examples are intended to illustrate an embodiment of the disclosure and should not be interpreted as limiting the scope set forth in the claims.

The following ingredients are referred to in Table 1 in respect to examples Ex. 1 and comparatives C. 1 and C. 2.

### Cyclosiloxane Oligomers (Cyclics Dx)

D4 was octamethylcyclotetrasiloxane supplied 98% pure from MiliporeSigma of Burlington Massachusetts USA;
D5 was decamethyl cyclopentasiloxane supplied 97% pure from MiliporeSigma of Burlington Massachusetts USA;
D6 was dodecamethyl cyclohexasiloxane from Gelest Inc. of Morrisville, Pennsylvania USA.

### End-Blockers

Vinyl end-blocker (vinyl): dimethylvinyl-terminated polydimethylsiloxane having an average degree of polymerisation of 20.

### Base Catalyst

The sodium silanolate used as the catalyst was prepared prior to the polymerisation process via the following process:

D5 (50.0 g, 0.135 mol), dry cyclohexane (17.3 g, 0.206 mol, 22.2 mL) and finely ground sodium hydroxide pellets (2.1 g, 0.052 mmol) were introduced into a 3-neck 250 mL round bottom flask equipped with a stir bar, Dean Stark trap, reflux condenser and thermocouple. The Dean Stark trap was filled with dry cyclohexane to prevent changes in concentration as the reaction proceeded. The reaction mixture was purged with nitrogen for 15 minutes, and then blanketed with nitrogen gas. The mixture was then heated with stirring to 105° C. for 8 h.

The resulting reaction product was then was cooled to room temperature, and vacuum was pulled to remove any remaining cyclohexane. The resulting catalyst was titrated with ~0.1 M HCl to determine base neutral equivalents following procedure Dow Silicones Corporation corporate test method (CTM) 0059 (which is available to the public upon request), and this was determined to be 500.7 mg KOH/g.

The resulting catalyst was either used on the same day as it was prepared or was stored in a laboratory freezer at a selected temperature below −25° C. to maximize long-term stability.

### Dodecamethyl Cyclohexasiloxane (D6) Polymerisation

A sample of D6 (49.10 g, 110.4 mmol) was weighed out into a 100 mL base of a polymerization reactor. The polymerisation reactor containing the D6 was assembled and purged with nitrogen for 20 minutes before heating commenced. The reactor headspace was initially swept with nitrogen and was then subsequently placed under a blanket of nitrogen for the remainder of the reaction.

Once the reactor reaches an internal temperature of 160° C., endblocker is added (0.67 g, 0.65 mmol). After a short mixing period sodium silanolate catalyst (1.00 g, 10% in D6, 2.75 mmol, 98.1 ppm) was added.

The reaction temperature is maintained at 160° C. and stirring continued over the course of the reaction. After 2 hours, a 2.5 wt. % solution of octyl silyl phosphonate in D5 (0.8 g, 3.52 mmol) was then added to neutralize the catalyst. After cooling, stirring is stopped, and the polymer is collected once the reaction mixture has completely cooled to room temperature.

The same polymerisation process was undertaken for comparatives C. 1 and C. 2 with the only difference being the polymer used in C. 1 and the catalyst used in C. 2. The potassium silanolate catalyst utilised in C. 2 was made using the same process as described above but using ground potassium hydroxide pellets. The ingredients utilised and reaction temperatures used are provided in Table 1 below.

TABLE 1
Starting ingredients and reaction temperature used for
Example 1 and comparative examples C. 1 and C. 2

| Example | Cyclic Dx | target DP | Endblocker | reaction temp. (° C.) |
|---|---|---|---|---|
| C. 1 | 4 | 900 | vinyl | 160 |
| C. 2 | 6 | 900 | vinyl | 120 |
| Ex. 1 | 6 | 897 | vinyl | 160 |

The Mw and Mn results in Table 2 below were determined using size exclusion chromatography. The amount of cyclics remaining after completion of the ring opening polymerisation process was determined by means of nuclear magnetic resonance (NMR) and in the case of C. 2 and C. 3 these were confirmed by volatiles analysis. Further details on the test methods are discussed below.

### Size Exclusion Chromatography (SEC or GPC):

GPC samples were prepared as 2 mg/mL samples in toluene and were run on an Agilent™ 1260 GPC with Mixed C or D columns and a refractive index detector. Samples were run with a toluene eluent at a flow rate of 1.00 mL/min at a temperature of 35° C.

### Nuclear Magnetic Resonance (NMR):

¹H and ²⁹Si NMR were taken on a Varian 400 MHz spectrometer with a Bruker SampleExpress autosampler and a cryoprobe. ²⁹Si NMR samples were prepared as solutions in CDCl₃ with ~10⁻² M chromium (III) acetoacetonate (Cr(acac)₃) as a spin relaxation agent.

The polymerisation results are provided in Table 2 below:

TABLE 2
Results of Polymerisation Process for C. 1, C. 2 and Ex. 1

| Example | Mn | Mw | PDI | % D4 (NMR) |
|---|---|---|---|---|
| C. 1 | 64090 | 107349 | 1.7 | 5.7 |
| C. 2 | 67118 | 117330 | 1.7 | 4.7 |
| Ex. 1 | 70426 | 126989 | 1.8 | 1.3 |

It will be seen in Table 2 that comparative C. 1 shows the typically used polymerization of octamethylcyclotetrasiloxane with standard levels of residual octamethylcyclotetrasiloxane.

C. 2 shows the case with the polymerization of dodecamethyl cyclohexasiloxane with potassium silanolate, where standard levels of octamethylcyclotetrasiloxane are formed. Finally, it can be seen in Table 2 that Ex. 1 shows the inventive case where dodecamethyl cyclohexasiloxane is polymerized with sodium silanolate, and cyclic levels are reduced—demonstrated by the low levels of residual octamethylcyclotetrasiloxane.

### Lab Scale LSR

An experimental LSR was prepared to test vinyl polymer made in accordance with the process herein. The LSR used standard ingredients for an LSR in the laboratory.

### Composition of Lab Scale LSR

The liquid silicone rubber (LSR) was made in a Max 100 dental cup mixer. The mixing was done in a Flaktek Dental Cup mixer at 2000 rpm for 30 seconds. The LSR formulation was mixed after the addition of every ingredient and the sides of the dental cup scraped down after mixing and before the addition of the next ingredient. The order of addition was:
Dimethylvinyl terminated polydimethyl siloxane prepared in accordance with the process herein (20.25 g)
Min-U-Sil™ 5 Ground Silica (1.3 g) commercially available from Western Reserve Chemicals
Cab-O-SIL™ TS 530 Trimethylsilylated fumed silica from Cabot Corp. (2.6 g added in 3 portions)
A siloxane polymer cross-linker having at least three Si—H bonds per polymer (0.152 mL)
A Chain Extender (0.565 mL)
3,5-Dimethyl-1-hexyn-3-ol Inhibitor (0.062 mL)
A Pt Catalyst (0.094 mL, 90 ppm Pt basis)

The LSR laboratory sample was prepared by mixing all of the ingredients to make an uncured LSR composition. The latter was scraped out on to a piece of PTFE (polytetrafluoroethylene) coated fabric. Then, a 100 mm×100 mm×3 mm mold was place around the uncured LSR and another piece of PTFE coated fabric placed on top of it.

The mold with the LSR in it was placed in a heated (Carver) press and compression molded at 10,000 lbs pressure (68.5 MPa) for 10 minutes. The molded article was then placed in an oven with a nitrogen sweep set at 200° C. for 2 hrs. The material was removed from the oven and cooled. Tensile testing bars (dogbones) were punched from the molded plaque. The Shore A hardness of the material was observed to be a value of 3 in accordance with ASTM D 2240. The tensile testing bars were evaluated for Modulus, tensile strength and elongation at break in an Instron tensile testing apparatus using ASTM D412. The experimental results (average of 3 runs) were as follows:

TABLE 4
Physical Properties of Laboratory LSR.

| | | Modulus | Tensile | |
|---|---|---|---|---|
| | | at 100% | Strength @ | % Elongation |
| | Shore | extension | Break | @break |
| | Hardness | (MPa) | (MPa) | (%) |
| Experimental | 3 | 0.09 ± 0.010 | 0.88 ± 0.026 | 1470 ± 243 |
| LSR | | | | |

What is claimed is:

1. A base catalysed process for the preparation of linear or branched siloxane polymers and copolymers, by the ring-opening polymerisation of cyclosiloxane oligomers having six siloxane units per ring having six 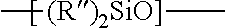
units per molecule, wherein each R″ group per unit is the same or different and is an alkyl group having from 1 to 6 carbons; which base catalysed process comprises the steps of
(a) introducing
(a) said cyclosiloxane oligomers having six siloxane units per ring in an amount of from 50 to 99 wt. % of the starting ingredients with
(ii) one or more end-blockers in an amount of from 1 to 50 wt. % of the starting ingredients and optionally
(iii) a co-monomer selected from a linear organosiloxane co-monomer, a branched organosiloxane co-monomer or cyclosiloxane co-monomer wherein said cyclosiloxane co-monomer has from 3 to 10 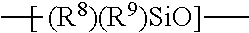
units per molecule, wherein each R⁸ group is the same or different and is selected from an alkenyl group, an alkynyl group, an aryl group, a fluoroalkyl such as trifluoropropyl or a perfluoroalkyl group and each R⁹ group is selected from an alkyl group having from 1 to 6 carbons or R⁸;
said co-monomer (iii), when present, being present in an amount of from 1 to 50 wt. % of the starting ingredients;
into a mixing vessel and mixing;
(b) optionally introducing an organic solvent in an amount of up to 30 wt. % of the starting ingredients into the mixing vessel during or subsequent to step (a);
(c) heating said starting ingredient (i) to a predetermined reaction temperature of from 25 to 175° C. in an inert atmosphere before introducing component (ii) and optionally component (iii), when present, or
heating a mixture of starting ingredients (i), (ii) and optionally (iii) to a predetermined reaction temperature of from 25 to 175° C. in an inert atmosphere;
(d) once the predetermined reaction temperature has been reached, and starting materials (i), (ii) and optionally (iii) are thoroughly mixed together, introducing a final starting ingredient, a sodium silanolate base catalyst (iv) of the structure R²⁰—O⁻ Na⁺ where R²⁰ is an organopolysiloxane chain; in an amount of from 0.001 to 10 wt. % of the starting ingredients; thereby forming an initial reaction mixture;
(e) agitating the initial reaction mixture at the predetermined reaction temperature for up to 24 hours until a step (e) product within a desired number average molecular weight range and/or a cyclics equilibration is obtained;
(f) quenching the reaction after step (e) by either filtering off heterogeneous acid catalysts when used or by neutralising the step (e) product with a suitable acid to form a step (f) product;
(g) Cooling the step (f) product to ambient temperature to form a cooled step (g) product and optionally,
(h) Stripping volatile cyclosiloxanes the cooled step (f) product to give a final linear or branched siloxane polymer or copolymer.

2. The base catalysed process for the preparation of linear or branched siloxane polymers and copolymers in accordance with claim 1 wherein the cyclosiloxane oligomers having six siloxane units per ring (i) comprise an oligomer consisting of six —[(R″)₂ SiO]— units per molecule, wherein each R″ group per unit is the same or different and is an alkyl group having from 1 to 6 carbons.

3. The base catalysed process for the preparation of linear or branched siloxane polymers and copolymers in accordance with claim 1, wherein the cyclosiloxane oligomers having six siloxane units per ring (i) comprise one or more oligomers of the structure [(CH₃)₂)SiO]₆, [(C₂H₅)₂)SiO]₆, [(C₃H₇)₂)SiO]₆, [(CH₃)(C₂H₅)SiO]₆ and/or [(CH₃)(C₃H₇)SiO]₆.

4. The base catalysed process for the preparation of linear or branched siloxane polymers and copolymers in accordance with claim 1, wherein end-blockers (ii) comprise one or more dimethylalkenyl-terminated polydimethylsiloxanes having a degree of polymerisation of from 10 to 350, trialkyl-terminated polydimethylsiloxanes or one or more disiloxanes.

5. The base catalysed process for the preparation of linear or branched siloxane polymers and copolymers in accordance with claim 1, wherein the end-blocker (ii) is selected from dimethyl vinyl-terminated polydimethylsiloxanes having a degree of polymerisation of from 10 to 100, dimethylhexenyl-terminated polydimethylsiloxanes having a degree of polymerisation of from 100 to 350, trimethyl-terminated polydimethylsiloxanes having a viscosity of from 15 to 200 mPa·s at 25° C., hexamethyldisiloxane, 1,1,3,3-tetramethyldisiloxane, and 1,3-divinyltetramethyldisiloxane.

6. The base catalysed process for the preparation of linear or branched siloxane polymers and copolymers in accordance with claim 1, wherein co-monomer (iii) comprises or consists of a cyclosiloxane co-monomer having from 3 to 10 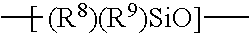
units per molecule, wherein each R⁸ group per is the same or different and is selected from an alkenyl group, an alkynyl group, an aryl group, a fluoroalkyl such as trifluoropropyl or a perfluoroalkyl group and each R⁹ group is selected from an alkyl group having from 1 to 6 carbons or R⁸.

7. The base catalysed process for the preparation of linear or branched siloxane polymers and copolymers in accordance with claim 1, wherein co-monomer (iii) comprises or consists of a trialkyl silyl-terminated and/or dialkylsilanol terminated linear or branched organopolysiloxane comprising units of the structure 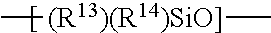
units per molecule, wherein each R¹³ group per is the same or different and is selected from an alkenyl group, an alkynyl group, an aryl group, a fluoroalkyl such as trifluoropropyl or a perfluoroalkyl group or a primary or secondary amine groups or alkylethylenediamine groups and each R¹⁴ group is selected from an alkyl group having from 1 to 6 carbons or R¹³.

8. The base catalysed process for the preparation of linear or branched siloxane polymers and copolymers in accordance with claim 1, wherein the organic solvent is present in an amount of up to 30 wt. % of the starting ingredients and is added into the mixing vessel during or subsequent to step (a).

9. The base catalysed process for the preparation of linear or branched siloxane polymers and copolymers in accordance with claim 8 wherein the organic solvent concerned is a linear, branched or cyclic aliphatic hydrocarbon which is optionally chlorinated; a linear, branched or cyclic ether or an aromatic solvent.

10. The base catalysed process for the preparation of linear or branched siloxane polymers and copolymers in accordance with claim 1, wherein in step (c) the mixture of starting ingredients is heated to a predetermined reaction temperature of from 100 to 175° C. in an inert atmosphere.

11. The base catalysed process for the preparation of linear or branched siloxane polymers and copolymers in accordance with claim 1, wherein the catalyst is a sodium silanolate base catalyst of the structure 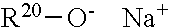
where R²⁰ is an organopolysiloxane chain, wherein the organopolysiloxane chain R²⁰ may have the structure: 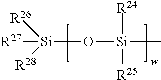
In which each R²⁴ may be the same of different and comprises an alkyl group having from 1 to 10 carbons, said alkyl group may be a substituted alkyl group containing chloro substituted alkyl groups or fluoro substituted alkyl groups;
each R²⁵ may be the same or different and may be R²⁴ or an alkenyl group having from 2 to 10 carbons;
Each of R²⁶, R²⁷ and R²⁸ may be the same or different and may be a hydroxyl group or R²⁵;
Each w is integer of from 2 and 150.

12. The base catalysed process for the preparation of linear or branched siloxane polymers and copolymers in accordance with claim 1, wherein the sodium silanolate base catalyst (iv) is selected from trimethyl or trialkyl sodium silanolates, polydimethylsilyl sodium silanolates,

13-15. (canceled)
